(19) United States
(12) Patent Application Publication
(10) Pub. No.: US 2007/0230898 A1
(43) Pub. Date: Oct. 4, 2007

(54) Random access searching with frame accuracy and without indexing within windows media video

(75) Inventors: Sudy Shen, Richmond Hill (CA); Bogdan Moldovean, Richmond Hill (CA)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Masstech Group Inc., Richmond Hill (CA)

(21) Appl. No.: 11/732,015

(22) Filed: Apr. 2, 2007

Related U.S. Application Data
(60) Provisional application No. 60/788,282, filed on Mar. 31, 2006.

(51) Int. Cl. H04N 5/91

(52) U.S. Cl. 386/68

(57) ABSTRACT

The present disclosure is directed to a process for generating a random access, frame accurate searchable file from a non-indexed video content file having an inconsistent frame rate. The process includes generating a fixed frame rate into the settings of the non-indexed video content file such as preprocessing video frame time-stamps to include frame_timestamp=frame_index*time_per_frame, where: time_per_frame=1/frame_rate. The non-indexed video content including the video frame time-stamps is encoded so that frame accurate searching includes conversions on frame rate settings using media time and a constant frame rate to convert from media time to frame number.

### CROSS REFERENCE TO RELATED APPLICATIONS

This application claims the benefit of U.S. Provisional Application No. 60/788,282, filed Mar. 31, 2006.

### BACKGROUND

This disclosure is directed to a system and process for creating video files in the Advanced System Format of Windows Media Video. More particularly, this disclosure is directed to a system and process for creating Windows Media Video files that include the ability for a user to random access search the files with frame accuracy and without having to index the files.

In this disclosure, “Windows” and “Windows Media” are used as trade designations of products available from the Microsoft Corporation of Redmond, Wash. A “codec” is a device or program capable of performing encoding and decoding on a digital data stream or signal. The word codec may be a combination of any of the following: “Compressor-Decompressor,” “Coder-Decoder,” or “Compression/Decompression” algorithm.

The Advanced Systems Format (ASF) is the file format used by Windows Media. Audio and video content compressed with a wide variety of codecs can be stored in an ASF file and played back with the ubiquitous Windows Media Player, streamed over networks with Windows Media Services, or optionally packaged with Windows Media Rights Manager. ASF is an extensible file format designed to store synchronized multimedia data. It supports data delivery over a wide variety of networks and protocols while still suitable for local playback. Files that include both audio and video compressed with Windows Media Audio and Windows Media Video codecs are Windows Media Video files (WMV) and are often designated with the computer file extension “.wmv”. Windows Media is a very popular format that has been used for years to create and deliver content over networks, such as the Internet, to all kinds of different users.

Creators of content in Windows Media Video files, however, have determined that this format is not without its limitations. For example, non-indexed Windows Media Video files do not exhibit a constant frame rate upon decoding and playback because not every frame in the file is necessarily output. Often, frames are dropped if the output program determines that they are not needed. The effect of this limitation is that prior to indexing of the file, a creator of content can not search non-indexed files with frame accuracy for editing, and the like. Indexing the files with device or program called an indexer, such as with Windows Media Format, can provide searching capability, but indexing is a very time consuming process that increases the time for creation of Windows Media Video content. Accordingly, there is a need for non-indexed Windows Media Video files that include the ability for a user to random access search the files with frame accuracy.

### SUMMARY

This disclosure is directed to a system and process that can create Windows Media Video files that includes the ability for a user to random access search the files with frame accuracy prior to indexing the files. For example, searching within a non-indexed Windows Media Video file with frame accuracy is accomplished by using media time, or running time, and using a constant frame rate to convert from media time to frame number. The present disclosure is directed to a system and process that forces a fixed-frame rate in the settings of the Windows Media Video encoding software, which can permit random access searching.

In one aspect, the present disclosure is directed to a process for generating a random access, frame accurate searchable file from a non-indexed video content file having an inconsistent frame rate. The process includes generating a fixed frame rate into the settings of the non-indexed video content file such as preprocessing video frame time-stamps to include

frame_timestamp=frame_index*time_per_frame,

where: time_per_frame=1/frame_rate.

The non-indexed video content including the video frame time-stamps is encoded so that frame accurate searching includes conversions on frame rate settings using media time and a constant frame rate to convert from media time to frame number.

In another aspect, the present disclosure is directed to a system for generating a random access, frame accurate searchable file from a non-indexed video content file having an inconsistent frame rate. The system includes a video decoder and a time-stamp preprocessor. The video decoder is used to decode the non-indexed video content file and create a decoded video content file. The time-stamp preprocessor includes an application to generate a fixed frame rate into the decoded video file wherein

frame_timestamp=frame_index*time_per_frame, and

wherein time_per_frame=1/frame_rate.

In the cases where the non-indexed video content file also includes an audio component, the system can also include an audio/video splitter, an audio compression manager wrapper and an encoder. The audio/video separates the audio component from the video component of the file. The video component is provided to the video decoder and the audio component is provided to the audio decoder. The audio compression manager wrapper is coupled to the audio/video splitter. The encoder is coupled to the audio compression manager wrapper and the time-stamp preprocessor. In the case where the audio component and the video components are processed simultaneously, the resulting data from each process are brought together at the encoder.

### DESCRIPTION OF THE DRAWINGS

FIG. 1 is a block diagram of a process developed in accordance with the present disclosure.

### DESCRIPTION

This disclosure relates to a system and process for creating video files, such as Windows Media Video files, that include the ability for a user to random access search the files with frame accuracy and without having to index the files. The disclosure, including the figure, describes the system with reference to illustrative examples. Other examples are contemplated and are mentioned below or are otherwise imaginable to someone skilled in the art. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

Random access searching in Windows Media Video can be performed in two steps. The first step includes forcing a fixed frame rate into the settings of Windows Media File. The second step includes frame accurate searching within the non-indexed Windows Media Video with conversions on frame rate settings.

During the first step, the general Windows Media Video limitation of an inconsistent frame rate within Windows Media Video files is overcome by forcing a fixed frame rate in the settings of the Windows Media Video encoding process, such as by preprocessing video frame timestamps of video content prior to being sent to a Windows Media Video encoder. During the preprocessing, new video timestamps are calculated with the following process step:

frame_timestamp=frame_index*time_per_frame (1),

where: time_per_frame=1/frame_rate

In one example, the Windows Media Video files are created with an extensible multimedia framework with an architecture that can permit the use of applications that provide custom solutions such as forcing a fixed frame rate on the settings of the files. The process step (1) can be incorporated into an application, a component, or a filter on a filter-based framework, and applied to decoded video data prior to encoding.

One preferred example of a suitable extensible multimedia framework is sold under the trade designation of DirectShow, which is a multimedia framework and application programming interface (API) produced by Microsoft Corporation of Redmond, Wash. for software developers to perform various operations with media files. DirectShow is based on a Component Object Model (COM) framework, and it provides a common interface for media across many of Microsoft's programming languages, and is an extensible, filter-based framework that can render or record media files. DirectShow divides the processing of multimedia tasks into a set of steps often referred to in the art as filters, or COM objects. A set of filters operating together is often called a filter graph. Each filter represents a stage in the processing of the data. DirectShow provides access to the underlying stream control architecture for applications that require custom solutions. In one example of the use of DirectShow to implement a filter of process step (1), DirectShow can be extended by incorporating the process step as a C++ application and implemented as a COM object. More directly, the filter can be built with DirectShow Software Developers Kit (SDK) available from Microsoft Corporation.

During the second step, i.e, frame accurate searching within the non-indexed Windows Media Video with conversions on frame rate settings, searching within a non-indexed Windows Media Video file with frame accuracy is accomplished by using media time, or running time, and a constant frame rate to convert from media time to a frame number. Frame accurate searches are performed using the following conversion on the frame rate settings such as the process steps of:

media_time=frame_index*time_per_frame (2); or

frame_index=media_time/time_per_frame (3)

Again, one skilled in the art can adapt these process steps into a multimedia framework such as into a filter used with DirectShow. In one example of the use of DirectShow to implement a filter of process steps (2) or (3), DirectShow can be extended by incorporating the process step as a C++ application and implemented as a COM object.

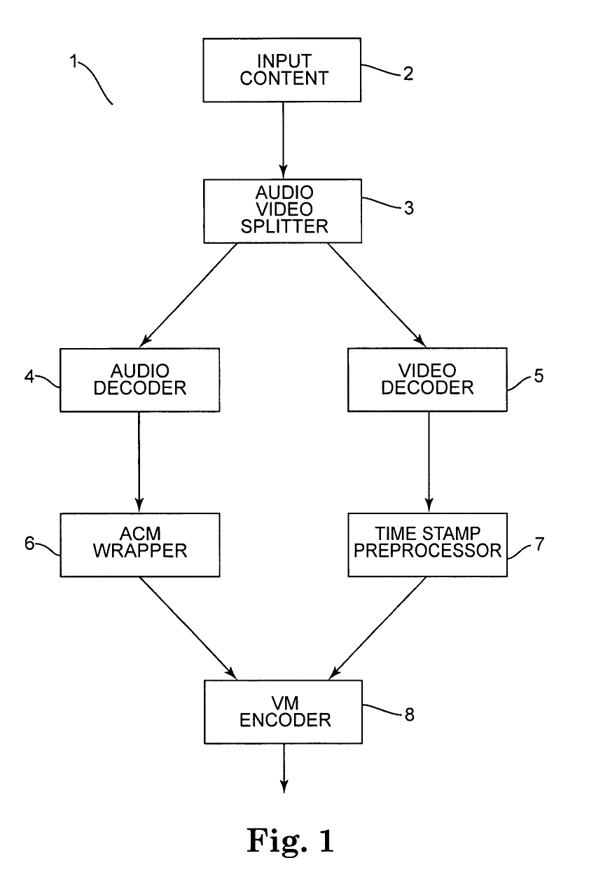

FIG. 1 is block diagram of the creation of a non-indexed Windows Media Video file that can be searched with frame accuracy. Features of the block diagram can be implemented as a method, a device, or as applications in a multimedia framework. The system receives an encoded content at an input module 2, where the content can include a Windows Media Video encoded content. The encoded content can include both audio and video data components. For example, Windows Media Video files can include both audio and video compressed with Windows Media Audio and Windows Media Video codecs. The input module 2 provides the file to an audio/video splitter 3 to separate the file into its two components. The audio component, or audio data, is processed by an audio decoder 4 and a wrapper 6, such as an audio compression manager (or ACM) wrapper, in succession. The ACM wrapper provides an application or filter that enables audio compression manager codecs to join a filter graph. The video component or data is processed by video decoder 5 that provides a decoded version of the video to a timestamp preprocessor 7. The timestamp preprocessor 7 applies an application or filter incorporating process step (1), above, to the decoded data, where each frame is time-stamped. In the example, the audio data and video data are processed concurrently, or in parallel. It is contemplated that the audio and video data can be processed in another order of steps. In the present example, after the audio data is “wrapped” and the video data is “time-stamped,” the audio and video data are brought together again in an encoder 8. The encoder 8 creates a file that now permits frame accurate searching under the process steps (2) or (3) above. In one example, the encoder 8 is a Windows Media Encoder application.

What is claimed is:

1. A process for generating a random access, frame accurate searchable file from a non-indexed video content file having an inconsistent frame rate, the process comprising:
generating a fixed frame rate into settings of the non-indexed video content file including preprocessing video frame time-stamps of video content wherein
frame_timestamp=frame_index*time_per_frame, and
wherein time_per_frame=1/frame_rate; and
encoding the non-indexed video content file including the preprocessed video frame time-stamps;
wherein frame accurate searching within the encoded non-indexed video content file includes conversions on frame rate settings using a media time and a constant frame rate to convert from media time to a frame number.

2. The process of claim 1 wherein frame accurate searches are performed using a conversion process on the frame rate settings including one of:
media_time=frame_index*time_per_frame, or
frame_index=media_time/time_per_frame.

3. The process of claim 1 including application of an extensible multimedia framework to preprocess the video frame time-stamps of video content and encode the non-indexed video content files.

4. A system for generating a random access, frame accurate searchable file from a non-indexed video content file having an inconsistent frame rate, the system comprising:
a video decoder to decode the non-indexed video content file and create a decoded video content file; and
a time-stamp preprocessor having an application to generate a fixed frame rate into the decoded video file wherein
frame_timestamp=frame_index*time_per_frame, and
wherein time_per_frame=1/frame_rate.

5. The system of claim 4 and further comprising an encoder operably coupled to the time-stamp preprocessor.

6. The system of claim 4 wherein the non-indexed video content file includes an audio component, and the system further comprises:
an audio/video splitter to separate the audio component from a video component, wherein the video component is provided to the video decoder and the audio component is provided to an audio decoder; and
an audio compression manager wrapper operably coupled to the audio/video splitter; and
an encoder operably coupled to the audio compression manager wrapper and the time-stamp preprocessor.
